(19) United States
(12) Patent Application Publication
(10) Pub. No.: US 2019/0009667 A1
(43) Pub. Date: Jan. 10, 2019

(54) MOTOR VEHICLE COOLANT HEAT EXCHANGER HAVING A WINDABLE COVERING SYSTEM HAVING A MODIFIABLE WINDING SPEED, AND PULLING MEANS ADAPTEN THERETO

(71) Applicant: Röchling Automotive SE & Co. KG, Mannheim (DE)

(72) Inventors: Maik Eno Steffen, Erfurt (DE); Richard Podzimski, Ilsede (DE); Kabir kumar bhanja, Koln (DE)

(73) Assignee: Röchling Automotive SE & Co. KG, Mannheim (DE)

(21) Appl. No.: 16/027,485

(22) Filed: Jul. 5, 2018

(30) Foreign Application Priority Data
Jul. 6, 2017 (DE) 102017211577.7

(51) Int. Cl. B60K 11/08; F01P 7/12

(52) U.S. Cl. CPC B60K 11/085; F01P 2025/08; F01P 7/12

(57) ABSTRACT

A motor vehicle coolant heat exchanger having a modifiable covering system includes a support, a winding shaft mounted rotatably around a winding axis, a rotational drive, a roller-blind web, at least one pulling means winding body connected to the winding shaft to rotate together, and a pulling means. The roller-blind web is windable onto and unwindable from the winding shaft along a winding trajectory, which comprises a pulling crosspiece at its longitudinal end region located remotely from the winding shaft. The pulling means is unwindable from and windable onto the pulling means winding body parallel to the winding trajectory, which is connected at its longitudinal end remote from the pulling means winding body to the pulling crosspiece. The pulling means is guided around a deflection roller in such a way that its longitudinal end connected to the pulling crosspiece moves away from the winding shaft while it is being wound on.

The present Application relates to a motor vehicle coolant heat exchanger whose cross section through which convective cooling air can flow is modifiable by way of a covering system unwindable from and windable onto a winding shaft. This serves to modify the heat-exchange performance of the motor vehicle coolant heat exchanger, in particular as an adaptation to sensorially detected operating states of the coolant circuit to which the motor vehicle coolant heat exchanger belongs, and/or of the internal combustion engine, cooled by the coolant circuit with participation of the motor vehicle coolant heat exchanger, of a motor vehicle.

Air flap arrangements, in which air flaps are provided in a flowthrough opening of the vehicle rotatably around their longitudinal axis, are known for modifying convective cooling air flows to motor vehicle coolant heat exchangers in motor vehicles. The air flaps pass through the flowthrough opening, and are mounted at their oppositely located longitudinal ends on a support that at least partly surrounds the flowthrough opening.

The flowthrough opening at the radiator grill allows convective cooling of functional assemblies arranged in the engine compartment and, in particular, allows convective cooling of the motor vehicle coolant heat exchanger that is part of the coolant circuit of an internal combustion engine in the engine compartment. The motor vehicle coolant heat exchanger is usually arranged behind the flowthrough opening in a flowthrough direction, so that air that flows through the flowthrough opening encounters the heat exchanger. The motor vehicle coolant heat exchanger is arranged relatively far away from the flowthrough opening in a flowthrough direction, however, so that even when the air flap arrangement is closed, convective flows that can have a cooling effect on the heat exchanger can undesirably occur between the air flap arrangement and a flow incidence surface of the motor vehicle coolant heat exchanger.

The amount of convective cooling of the assemblies arranged behind the flowthrough opening in a flowthrough direction can be adjusted by modifying the air flow-capable cross section of the flowthrough opening. Upon initial operation of the internal combustion engine of the vehicle, for example, it can be useful to close off the flowthrough opening over the largest possible area in order to avoid convective cooling of the internal combustion engine, so that the internal combustion engine attains, as quickly as possible, its rated operating temperature at which its emissions output per unit time is lower than in thermally transient heating-up phases.

As a result of the known rotatable mounting of air flaps at their respective longitudinal ends on oppositely located supporting parts of the support that surrounds the flowthrough opening, the air flaps pass through the flowthrough opening in any of their operating positions, so that the air flaps cover a portion of the flowthrough opening even when they are in their completely open position. As a rule, the air flaps are displaceable only between an open position with a maximum flowthrough cross section and a closed position in which no flowthrough cross section is available.

The object of the present invention is therefore to configure the heat-exchanger performance of a motor vehicle coolant heat exchanger of a motor vehicle to be modifiable as steplessly and accurately as possible with the greatest possible operating reliability.

This object is achieved according to the present invention by a motor vehicle coolant heat exchanger having a covering system, modifiable via a winding motion, for modifying an air flow-capable cross section of the motor vehicle coolant heat exchanger, encompassing:
a support stationary relative to the radiator heat exchanger;
a winding shaft mounted on the support rotatably around a winding axis;
a rotational drive, mounted on the support, for driving the winding shaft to rotate around the winding axis;
a roller-blind web, windable onto and unwindable from the winding shaft along a winding trajectory, which is connected to the winding shaft at its one longitudinal end region with respect to the winding trajectory, and comprises a pulling crosspiece at its other longitudinal end region located oppositely with respect to the winding trajectory;
at least one pulling means winding body that is connected to the winding shaft for rotation together;
a pulling means that is unwindable from and windable onto the pulling means winding body parallel to the winding trajectory, the pulling means being connected at one end to the pulling means winding body and at the other end to the pulling crosspiece, the pulling means being guided, in its extent between the pulling means winding body and the pulling crosspiece, around a deflection roller in such a way that that longitudinal end of the pulling means which is connected to the pulling crosspiece moves away from the winding shaft while it is being wound on,

the pulling means and the roller-blind web being connected for a winding motion counterdirectionally with their respective winding body, namely the pulling means winding body and winding shaft, so that the pulling means is unwound from the pulling means winding body while the roller-blind web is wound onto the winding shaft, and vice versa, the winding radius of the pulling means winding body changing in a winding portion, along its axial extent, in such a way that during a rotational motion of the pulling means winding body in the pulling means winding-on direction, the length of a pulling means portion, wound on in successive rotational portions of the pulling means winding body which have the same rotational angle magnitude, decreases.

The support serves here as a base or frame of the assembly according to the present invention made up of the motor vehicle coolant heat exchanger having the covering system modifiable by a winding motion, to and on which frame all the components and assemblies belonging to the covering system can be directly or indirectly connected or mounted. The motor vehicle coolant heat exchanger advantageously can itself be the aforesaid support. The support can also be entirely or partly constituted by the motor vehicle supporting the motor vehicle coolant heat exchanger.

Thanks to the use of a roller-blind web, a flow incidence surface of the motor vehicle coolant heat exchanger which is embodied for incident flow of convective cooling air can be steplessly covered or exposed, for air to flow through, by winding and unwinding the roller-blind web. The roller-blind web can, for that purpose, be wound onto and unwound from a winding shaft. The winding shaft can be embodied in one piece or in several parts. The unwound roller-blind web can advantageously extend parallel to the flow incidence surface. The unwound roller-blind web can be arranged close to the flow incidence surface as compared with an air flap arrangement recited previously. The distance of the unwound roller-blind web from the flow incidence surface can be less than 11 cm, advantageously even less than 7 cm or even less than 4 cm.

In order for the roller-blind web to be reliably windable onto the winding shaft, it is connected to the winding shaft at its longitudinal end region located closer to the winding shaft. The connection can be positively engaging and/or frictional or nonpositive and/or intermaterial. To ensure dependable unwinding of the roller-blind web, it is provided with a pulling crosspiece at its oppositely located other end.

According to the present invention the unwinding of the roller-blind web occurs in pulling means-assisted fashion so that upon a rotational motion of the winding shaft in the unwinding direction the roller-blind web can move not solely in gravity-driven fashion along the flow incidence surface of the motor vehicle coolant heat exchanger, and in that context possibly become canted, and so that the roller-blind web can be unwound from the winding shaft not solely in a gravity action direction. The pulling means, advantageously a flexurally limp pulling means such as a cable, belt, or chain, exerts on the pulling crosspiece, during an unwinding motion of the winding shaft, a pulling force acting along the winding trajectory in a direction away from the winding shaft.

With the configurations according to the present invention which are described above, this can occur by means of a single rotational drive that drives both the winding shaft and the pulling means winding body, connected to the winding shaft for rotation together around the winding axis, to rotate around the winding axis.

The pulling means, which is likewise unwindable and windable proceeding from the winding axis, is wound onto the pulling means winding body counterdirectionally to the winding of the roller-blind web onto the winding shaft. The pulling means is therefore wound onto the pulling means winding body when the roller-blind web is unwound from the winding shaft, and the pulling means is unwound from the pulling means winding body when the roller-blind web is wound onto the winding shaft. Although the pulling means, like the roller-blind web, proceeds from the winding axis, the use of the aforesaid deflection roller allows a pulling force to be exerted on the pulling crosspiece of the roller-blind web upon winding of the pulling means onto the pulling means winding body, thereby allowing the unwinding of the roller-blind web to be assisted and ensured.

Because the pulling means, in contrast to the roller-blind web, as a rule exhibits no appreciable extent in an axial direction along the winding axis due to the limited installation space available in motor vehicles, turns of the pulling means can be located axially next to one another on the pulling means winding body, while turns of the roller-blind web end up located only radially above one another on the winding shaft.

The result of this is that for a constant rotation speed of the winding shaft, the speed of the pulling crosspiece along the winding trajectory decreases with increasing distance from the winding shaft, and rises with increasing proximity to the winding shaft. This is because the trajectory speed of the pulling crosspiece along the winding trajectory depends on the winding radius of the winding shaft, which becomes larger with increasing winding of the roller-blind web onto the winding shaft and becomes smaller as it is increasingly unwound from the winding shaft.

To ensure that the sum of the unwound lengths of the pulling means on the one hand and of the roller-blind web on the other hand is approximately constant over a wide range of operating positions achievable by the roller-blind web, the pulling means winding body is embodied in one winding portion in such a way that the winding radius changes in the winding portion along its axial extent. It is thereby possible for the speed of that longitudinal end of the pulling means which is connected to the pulling crosspiece to change, during a winding motion of the roller-blind web, to approximately the same extent as the web speed of that longitudinal end of the roller-blind web which is connected to the pulling crosspiece, even though the turns of the pulling means, unlike the turns of the roller-blind web, can end up located axially next to one another on the pulling means winding body. Operating phases with a slack or excessively tensioned pulling means are thereby avoided.

The pulling means winding body is preferably connected to the winding shaft for rotation around the winding axis constituting a common rotation axis. The possibility is not to be excluded, however, that the pulling means winding body is rotatable around a winding body rotation axis enclosing an angle, in particular a right angle, with the winding axis. The pulling means winding body can then be coupled, via a corresponding linkage, for rotation together with the winding shaft. This has the advantage that the location at which the pulling means is wound onto and unwound from the pulling means winding body respectively during a winding and unwinding operation changes less severely, in an axial direction along the winding axis, than if the pulling means winding body also rotated around the winding axis. This is advantageous because those longitudinal ends of the pulling crosspiece to which the pulling means is connected also do not move in an axial direction during a winding operation.

Because such a motion conversion between angled rotation axes results in costs, however, it is preferred to connect the winding body and winding shaft rigidly to one another and to arrange both components on the support rotatably around the winding axis constituting a common rotation axis.

When an “axial” direction is referred to in the present Application, this is always the axial direction with respect to the rotation axis of the particular component being discussed. If the component itself is not rotatable, the axial direction refers to the winding axis. For the preferred case in which both the pulling means winding body and the winding shaft are rotatable around the winding axis constituting a common rotation axis, the indication of an “axial” direction always refers to the winding axis. A “radial” direction referred to in the present Application is accordingly oriented orthogonally to the respective axial direction, and a “circumferential” direction extends around the respective axial direction.

Because the winding radius of the winding shaft having the roller-blind web changes linearly with the winding state of the roller-blind web on the winding shaft, it is advantageous if the winding radius of the winding portion also changes linearly along the rotation axis of the pulling means winding body. Provision is therefore preferably made that the winding portion of the pulling means winding body tapers conically in its axial direction.

In order to achieve a defined winding state of the pulling means on the pulling means winding body, it is furthermore advantageous if the winding portion of the pulling means winding body comprises a helical groove in which the pulling means is received in the wound-on state. The axial distance between two axially adjacent pulling means turns on the pulling means winding body is then physically defined. The radius of the helical groove then changes, preferably continuously and with a constant magnitude of change, from one turn to the next.

To further ensure a defined winding state of the pulling means on the pulling means winding body, the pulling means winding body can be surrounded externally at a radial distance by a support-mounted housing that, for example, is at a constant radial distance from the winding portion. It is thereby possible to prevent a situation in which the pulling means, instead of following the course of the helical groove, jumps oppositely to the axial extension direction over the helical groove portion that is still unoccupied, i.e. not yet occupied by a wound-on pulling means portion, and then abuts in uncontrolled fashion against the pulling means winding body. The housing surrounding the pulling means winding body therefore preferably has a negatively conical inner wall that is located radially oppositely from the conical winding portion of the pulling means winding body. The inner wall of the housing is preferably smooth, since the pulling means received in the helical groove must be able to execute a relative motion around its rotation axis relative to the housing and, because of the helical groove, the direction in which the already wound-on pulling means portion proceeds also has a component in an axial direction.

To ensure that the sum of the unwound roller-blind web and unwound pulling means is approximately constant over a large portion of the possible intended operating positions of the roller-blind web, provision is advantageously made that the magnitude of the change in the winding radius of the helical groove per turn differs from the thickness of the roller-blind web by no more than 10%, preferably by no more than 5%. This is because the change in winding radius for each revolution of the assembly made up of the winding shaft and roller-blind web corresponds to the thickness of the roller-blind web. If the roller-blind web is elastic or partly elastic, a determination must be made, by experiment, of the extent to which the roller-blind web deforms while being wound on. Advantageously, the winding radius actually occurring at the winding shaft is to be ascertained, and the pitch of the helical groove is to be determined therefrom.

Preferably, however, the roller-blind web deforms very little under the loads that occur in the context of operation, so that the percentage differences indicated above between the turn-specific change in the radius of the helical groove and the thickness of the roller-blind web are correct in terms of the desired consistency of the sum of the unwound lengths of the pulling means and roller-blind web.

In principle, the rotational drive can be coupled for torque transfer at any point on the assembly made up of the winding shaft and pulling means winding body. Preferably, however, the pulling means winding body is located in the torque transfer path along which drive torque is transferred from the rotational drive to the winding shaft. The pulling means winding body thus also serves to transfer drive torque from the rotational drive to the winding shaft.

This can be achieved in terms of design, for example, by the fact that a torque output part of the rotational drive is directly coupled in torque-transferring fashion to the pulling means winding body.

In order to allow even particularly wide roller-blind webs, i.e. ones that are axially long with respect to the winding axis, to unwind from and wind onto the winding shaft without canting, provision can advantageously be made that a respective pulling means winding body, having a respective pulling means, is connected to the winding shaft axially on both sides of the roller-blind web for rotation together around the winding axis. In this case only one of the two pulling means winding bodies is arranged in the torque transfer path between the winding shaft and rotational drive, and a torque output part of the rotational drive is directly coupled in torque-transferring fashion only to one of two pulling means winding bodies.

In order to allow a correct position of the roller-blind web to be furnished, regardless of its winding state on the flow incidence surface, even in the context of air flow loads occurring during operation, according to a refinement of the present invention provision can be made that the support encompasses two guide rails, extending parallel to the winding trajectory and arranged with a distance from one another parallel to the winding axis, which each guide an edge portion, extending along the winding trajectory, of the roller-blind web during the winding and unwinding motion of the roller-blind web. The guide rails can be arranged directly on the motor vehicle coolant heat exchanger as the support or as a part of the support. The roller-blind web can then be guided past the flow incidence surface of the motor vehicle coolant heat exchanger at a very short distance, for example less than 2 cm.

The pulling crosspiece is preferably also guided by the guide rails. The pulling crosspiece preferably passes through both guide rails axially, i.e. parallel to the winding axis, the attachment of the pulling means to the pulling crosspiece preferably occurring on that side of the respective guide rail which faces away from the roller-blind web.

In order for the distance of the roller-blind web from the flow incidence surface of the motor vehicle coolant heat exchanger to be constant regardless of its winding state, and thus to be able to ensure constant occlusion of the flow incidence surface in the region covered by the roller-blind web, the winding trajectory preferably extends parallel to the flow incidence side of the motor vehicle coolant heat exchanger.

The present invention furthermore relates to a vehicle having a motor vehicle coolant heat exchanger having a covering system, modifiable by way of a winding motion, as described and refined above.

The present invention will be explained in more detail below with reference to the appended drawings, in which:

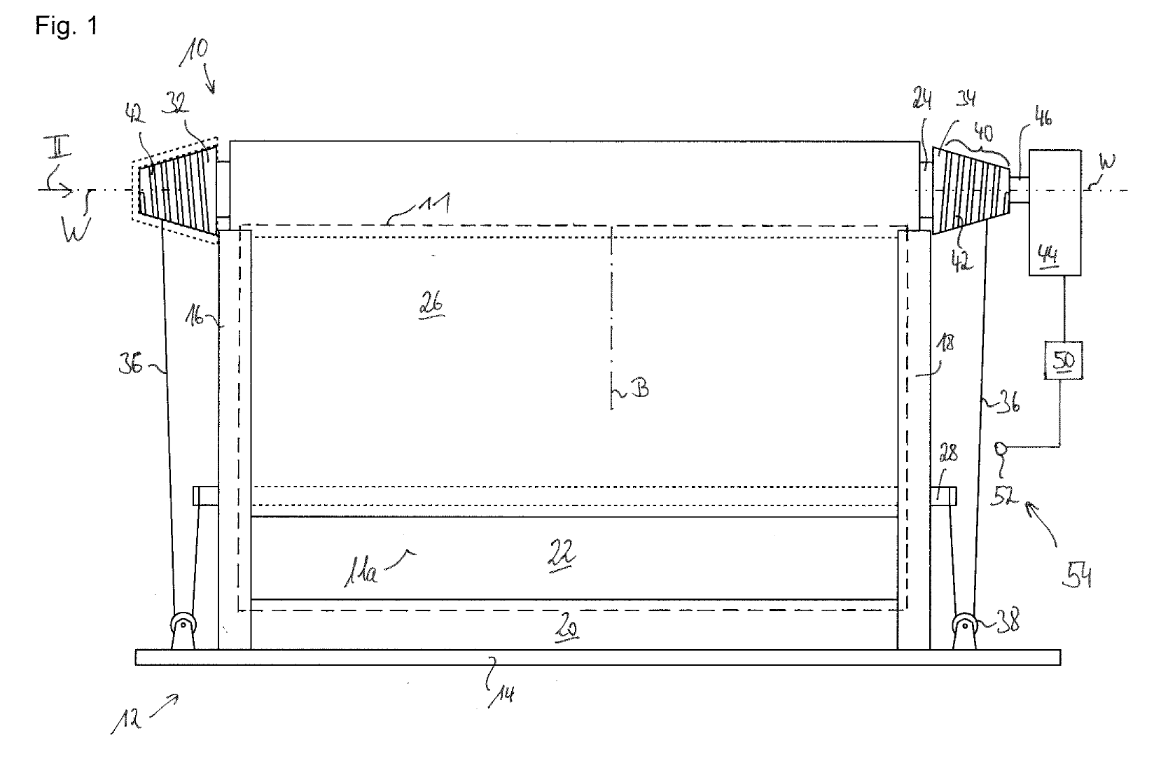

FIG. 1 is a schematic plan view, in a flow incidence direction, of an embodiment according to the present invention of a motor vehicle coolant heat exchanger having a modifiable covering system in accordance with the present Application; and

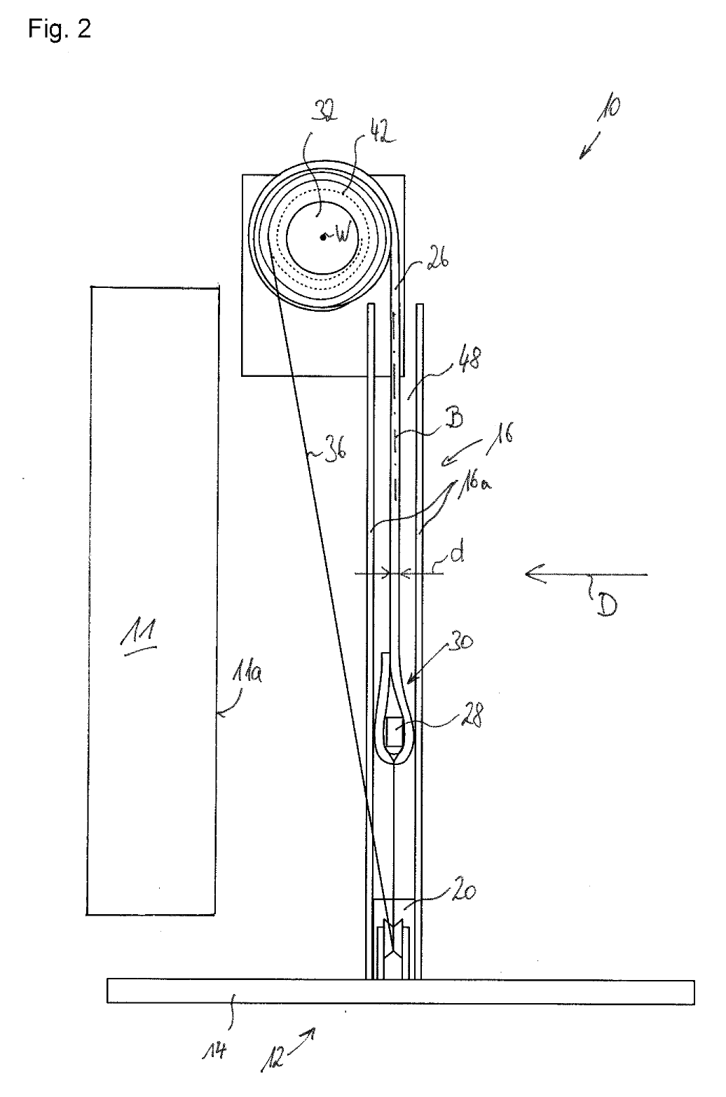

FIG. 2 is a side view of the motor vehicle coolant heat exchanger having a modifiable covering system of FIG. 1.

In FIGS. 1 and 2, an embodiment according to the present invention of a system for covering a motor vehicle coolant heat exchanger 11 is labeled generally as 10. FIG. 1 shows the embodiment as viewed in a flow incidence direction D (see FIG. 2), and FIG. 2 shows the embodiment as viewed along winding axis W in the direction of arrow II in FIG. 1. The illustrations are not to scale.

The embodiment encompasses a support 12 having, for example, a bottom plate 14 as well as two guide rails 16 and 18. Also provided on the bottom plate is a delimiting bar 20 that delimits a flowthrough opening 22 surrounded by support 12, more precisely by guide rails 16 and 18, and by delimiting bar 20. Bottom plate 14 does not need to be a plate. It can also be merely a bar or the like. Motor vehicle coolant heat exchanger 11, which is merely indicated with dashed lines in FIG. 1, is located behind flowthrough opening 22 in flow incidence direction D.

The embodiment furthermore comprises a winding shaft 24 mounted, rotatably around a winding axis W, directly or indirectly on support 12, onto which shaft a roller-blind web 26 is windable along a winding trajectory B. Roller-blind web 26 is also unwindable from winding shaft 24 along winding trajectory B. Flowthrough opening 22 is not obligatorily necessary. In order to achieve the advantages of the present invention it is sufficient if roller-blind web 26 is movable along a flow incidence surface 11a of motor vehicle coolant heat exchanger 11.

At its longitudinal end located closest to winding shaft 24, roller-blind web 26 is connected to winding shaft 24, for example, by adhesive bonding and/or clamping and/or riveting, to name only a few possible examples.

At its longitudinal end located remotely from winding shaft 24 along winding trajectory B, roller-blind web 26 comprises a pulling crosspiece 28 that projects on both sides beyond roller-blind web 26 in an axial direction with respect to winding axis W. Pulling crosspiece 28 is received in positively engaging fashion in an end-located loop 30 of roller-blind web 26 along winding trajectory B. Loop 30 can be formed by folding over roller-blind web 26 and stitching and/or adhesively bonding it.

Provided on both axial sides of winding shaft 24 is a respective pulling means winding body 32 and 34 that is embodied mirror-symmetrically with respect to a mirror symmetry plane orthogonal to winding axis W and thus to the drawing plane of FIG. 1. Because of the symmetry condition indicated, it is sufficient to describe only pulling means winding body 34, the description thereof serving also, given the symmetry condition indicated, to describe pulling means winding body 32.

A cable 36, constituting an example of a pulling means, can be wound onto and unwound from pulling means winding body 34. Pulling means winding body 34 rotates together with winding shaft 24 around winding axis W constituting a common rotation axis. Cable 36 is connected, at its longitudinal end located remotely from winding body 34, to that longitudinal end of pulling crosspiece 38 which is located axially closer to winding body 34. Between pulling crosspiece 28 and winding body 34, cable 36 runs around a deflection roller 38 that is provided rotatably on support 12 (here, on bottom plate 14).

A winding portion 40 of pulling means winding body 34 is embodied in conically tapering fashion. Winding axis W, constituting the rotation axis of pulling means winding body 34, forms the cone axis of winding portion 40.

For defined arrangement of the wound-on longitudinal portions of cable 26, a helical groove 42, in which cable 36 abuts against winding body 34 upon winding, is embodied on the conical winding portion 40 of pulling means winding body 34.

The difference in radius between two immediately axially adjacent turns of helical groove 42 corresponds to thickness d of roller-blind web 26 (see FIG. 2).

In FIG. 2 the viewer is looking along arrow II of FIG. 1 toward covering system 10 and thus toward pulling means winding body 32. The helical groove also provided thereon is labeled 42 as it is on winding body 34. Groove 42 is indicated in FIG. 2, however, only by a single line and not, as in FIG. 1, by two parallel lines. The pulling means (cable) connected to pulling means winding body 32 is again labeled 36.

As is evident especially from FIG. 2, cable 36 and roller-blind web 26 are wound counterdirectionally around winding axis W, i.e. when roller-blind web 26 is unwound from winding shaft 24, cable 36 is simultaneously wound onto pulling means winding bodies 32 and 34, and vice versa.

A rotational drive 44 is directly connected to pulling means winding body 34 arranged on the right in FIG. 1. An output shaft 46 of the rotational drive is arranged coaxially with pulling means winding bodies 32 and 34 and with winding shaft 24, and is coupled directly for rotation together, preferably by positive engagement, to that longitudinal end region of pulling means winding body 34 which is located remotely from winding shaft 24. Torque outputted from rotational drive 44 via its output shaft 46 is thus transferred via pulling means winding body 34 to the winding shaft. Rotational drive 44 is drivable in opposite rotational directions so that roller-blind web 26 can be wound onto winding shaft 24, and unwound from it, in motorized fashion. Roller-blind web 26 can be steplessly unwound from, and wound onto, winding shaft 24. A flow incidence surface 11a of motor vehicle coolant heat exchanger 11 can thereby be steplessly covered by roller-blind web 26.

In contrast to what is depicted in FIGS. 1 and 2, winding shaft 24 is preferably arranged above radiator 11 so that roller-blind web 26 can be guided past flow incidence surface 11a at the closest possible distance parallel to flow incidence direction D upon unwinding.

The (preferably electric) rotational drive 44 is operated at a constant rated rotation speed while delivering a rated torque.

For a constant rotation speed of output shaft 46, the speed of pulling crosspiece 28 along winding trajectory B depends on the winding radius of the assembly constituted by winding shaft 24 and roller-blind web 26 wound onto it. The larger the winding radius, the more quickly pulling crosspiece 28 moves along winding trajectory B when rotationally driven at a constant rotation speed. This means that pulling crosspiece 28 becomes increasingly slower as roller-blind web 26 unwinds from winding shaft 24, and increasingly faster upon winding on.

In order to allow this change in speed as a function of the winding state of roller-blind web 26 also to be achieved with cables 36, winding portions 40 are embodied with the above-described conicity. For the reason recited, the winding radius of helical groove 42 differs, between immediately adjacent turns, by approximately the thickness d of roller-blind web 26. It is thereby possible to ensure that the sum of the unwound lengths of roller-blind web 26 on the one hand and of a cable 36 on the other hand is approximately constant over the operating states achievable as intended for occluding flow incidence surface 11a. Cables 36 can thus assist an unwinding motion of roller-blind web 26 by exerting a pulling force along winding trajectory B in a direction away from winding axis W, and can thus prevent roller-blind web 26 from canting upon unwinding. The winding of roller-blind web 26 onto winding shaft 24, conversely, is very largely non-critical.

As is evident from FIG. 2, a guide rail 16 encompasses two rail bodies 16a that form a gap 48 between them. Gap 48 passes completely through guide rail 16 in an axial direction, i.e. parallel to winding axis W, and is delimited by rail bodies 16a in a direction orthogonal to winding axis W and to winding trajectory B. Guide rail 18 is embodied mirror-symmetrically with respect to guide rail 16 with reference to a mirror symmetry plane orthogonal to winding axis W.

Rotational drive 44 can be connected to a vehicle controller 50, for example a microcomputer, that receives from sensors 52 operating information regarding vehicle 54 having covering system 10, for example regarding the coolant temperature of an internal combustion engine of vehicle 54.

As a function of the information received from sensors 52, vehicle controller 50 can apply control to rotational drive 44 to rotationally drive winding shaft 24 in order thereby, as a function of the operating state, to uncover or block flowthrough opening 22 in terms of a flow of convective cooling air, and thereby to allow flow incidence surface 11a of motor vehicle coolant heat exchanger 11 to be steplessly covered or not covered.

1. A motor vehicle coolant heat exchanger having a modifiable covering system for modifying an air flow-capable cross section of the motor vehicle coolant heat exchanger, comprising:
a support stationary relative to the radiator heat exchanger;
a winding shaft mounted on the support rotatably around a winding axis;
a rotational drive, mounted on the support, for driving the winding shaft to rotate around the winding axis;
a roller-blind web, windable onto and unwindable from the winding shaft along a winding trajectory, which is connected to the winding shaft at its one longitudinal end region with respect to the winding trajectory, and comprises a pulling crosspiece at its other longitudinal end region located oppositely with respect to the winding trajectory;
at least one pulling means winding body that is connected to the winding shaft for rotation together; and
a pulling means that is unwindable from and windable onto the pulling means winding body parallel to the winding trajectory, the pulling means being connected at one end to the pulling means winding body and at the other end to the pulling crosspiece, the pulling means being guided, in its extent between the pulling means winding body and the pulling crosspiece, around a deflection roller in such a way that that longitudinal end of the pulling means which is connected to the pulling crosspiece moves away from the winding shaft while it is being wound on, the pulling means and the roller-blind web being connected for a winding motion counter-directionally with their respective winding body, namely the pulling means winding body and winding shaft, so that the pulling means is unwound from the pulling means winding body while the roller-blind web is wound onto the winding shaft, and vice versa, the winding radius of the pulling means winding body changing in a winding portion, along its axial extent, in such a way that during a rotational motion of the pulling means winding body in the pulling means winding-on direction, the length of a pulling means portion, wound on in successive rotational portions of the pulling means winding body which have the same rotational angle magnitude, decreases.

2. The motor vehicle coolant heat exchanger, having a modifiable covering system, according to claim 1, wherein the winding portion of the pulling means winding body tapers conically in its axial direction.

3. The motor vehicle coolant heat exchanger, having a modifiable covering system, according to claim 2, wherein the winding portion of the pulling means winding body comprises a helical groove in which the pulling means is received in the wound-on state.

4. The motor vehicle coolant heat exchanger, having a modifiable covering system, according to claim 3, wherein the magnitude of the change in the winding radius of the helical groove per turn differs from the thickness of the roller-blind web by no more than 10%.

5. The motor vehicle coolant heat exchanger, having a modifiable covering system, according to claim 1, wherein the pulling means winding body is located in the torque transfer path for transferring drive torque from the rotational drive to the winding shaft.

6. The motor vehicle coolant heat exchanger, having a modifiable covering system, according to claim 5, wherein a torque output part of the rotational drive is coupled in torque-transferring fashion to the pulling means winding body.

7. The motor vehicle coolant heat exchanger, having a modifiable covering system, according to claim 1, wherein a respective pulling means winding body, having a respective pulling means, is connected to the winding shaft axially on both sides of the roller-blind web for rotation together around the winding axis.

8. The motor vehicle coolant heat exchanger, having a modifiable covering system, according to claim 1, wherein the support comprises two guide rails, extending parallel to the winding trajectory and arranged with a distance from one another parallel to the winding axis, which each guide an edge portion, extending along the winding trajectory, of the roller-blind web during the winding and unwinding motion of the roller-blind web.

9. The motor vehicle coolant heat exchanger, having a modifiable covering system, according to claim 1, wherein the winding trajectory extends parallel to a flow incidence side of the motor vehicle coolant heat exchanger.

10. A vehicle, having a motor vehicle coolant heat exchanger, having a modifiable covering system, according to claim 1.

11. The motor vehicle coolant heat exchanger, having a modifiable covering system, according to claim 3, wherein the magnitude of the change in the winding radius of the helical groove per turn differs from the thickness of the roller-blind web by no more than 5%.
